(19) United States
(12) Patent Application Publication
(10) Pub. No.: US 2021/0208295 A1
(43) Pub. Date: Jul. 8, 2021

(54) ITERATIVE MIGRATION VELOCITY OPTIMIZATION FOR A VSP SURVEY USING SEMBLANCE

(71) Applicant: Halliburton Energy Services, Inc.

(72) Inventors: Amit Padhi, Houston, TX (US); Mark Elliott Willis, Katy, TX (US)

(73) Assignee: Halliburton Energy Services, Inc., Houston, TX (US)

(21) Appl. No.: 16/074,642

(22) PCT Filed: Sep. 27, 2016
(86) PCT No.: PCT/US16/53953

§ 371 Date: Aug. 1, 2018

(51) Int. Cl. G01V 1/30; G01V 1/28; G01V 1/40

(52) U.S. Cl. CPC G01V 1/303; G01V 1/282; G01V 2210/512; G01V 2210/161; G01V 2210/6222; G01V 1/40

(57) ABSTRACT

A method to process vertical seismic profile (VSP) data includes receiving VSP data, migrating the VSP data output using an initial velocity model to produce migrated depth values associated with the respective receivers, sorting and collecting the migrated depth values corresponding to each receiver to produce a migrated common receiver gather (CRG) associated with each receiver, stacking the migrated depth values of the CRGs corresponding to respective fixed lateral positions in an image volume to produce a common image gather (CIG) associated with each lateral position, and generating a semblance panel having the stacked depth migration values plotted as contours on a first axis for velocity ratio (vr), which is based on migration velocity and true velocity) and a second axis for true depth (Zt). The method further includes updating the initial velocity model based on a plurality of data points selected from the semblance panel to provide an updated velocity model.

### TECHNICAL FIELD OF THE INVENTION

The embodiments disclosed herein generally relate to vertical seismic profiling (VSP) measurements of subterranean formations and, more particularly, to methods of iteratively optimizing a migration velocity model using semblance.

### BACKGROUND OF THE INVENTION

Hydrocarbons, such as oil and gas, are commonly obtained from subterranean formations that may be located onshore or offshore. Typically, subterranean operations involve a number of different steps such as, for example, exploration for selecting a drilling site, drilling a wellbore through and/or into the subterranean formation at a desired well site. treating the wellbore to optimize production of hydrocarbons, and performing the necessary steps to produce and process the hydrocarbons from the subterranean formation. Geophysical surveys of subterranean features are used to prepare for and guide such operations.

Vertical Seismic Profile (VSP) analysis is a technique commonly used to conduct geophysical surveys of subterranean features. For instance, a VSP survey can be used to image the earth's subsurface in the proximity of a wellbore during the drilling or operation of a well. In an example implementation, one or more seismic energy sources are located at the surface and one or more seismic receivers are located within a wellbore. Information regarding the subsurface is determined based on the detection of reflected seismic energy that originates from the seismic energy sources at the surface.

Data obtained during a VSP survey can be processed in multiple steps, usually including a step of depth migration. A velocity model that models velocity of energy propagation across an examined subsurface is a critical component of depth migration. An inaccurate velocity model causes distortion, such as blurring, of images generated by the VSP survey.

Accordingly, there is continued interest in the development of improved velocity models for use with a VSP survey.

### BRIEF DESCRIPTION OF THE SEVERAL VIEWS OF THE DRAWING

For a more complete understanding of the disclosed embodiments, and for further advantages thereof, reference is now made to the following description taken in conjunction with the accompanying drawings in which:

FIG. 1 is a schematic diagram illustrating an example vertical seismic profiling (VSP) system according to the disclosed embodiments;

FIG. 2 is a schematic diagram illustrating an example VSP system deployed in a wellbore according to the disclosed embodiments;

FIG. 3 is a block diagram illustrating an exemplary information processing system, in accordance with embodiments of the present disclosure;

FIG. 4A is a schematic diagram that illustrates an example logging while drilling (LWD) environment;

FIG. 4B is a schematic diagram that illustrates an example wireline logging environment;

FIG. 5 is a screenshot illustrating example migrated common receiver gathers (CRGs) in accordance with particular embodiments of the present disclosure;

FIG. 6 is a screenshot illustrating example Common Image Gathers (CIGs) in the receiver domain in accordance with particular embodiments of the present disclosure;

FIG. 7 is a screenshot illustrating an example semblance panel for a particular CIG location in accordance with particular embodiments of the present disclosure; and

FIG. 8 is a flowchart illustrating operations of a method in accordance with embodiments of the present disclosure.

### DETAILED DESCRIPTION OF THE DISCLOSED EMBODIMENTS

The following discussion is presented to enable a person skilled in the art to make and use the invention. Various modifications will be readily apparent to those skilled in the art, and the general principles described herein may be applied to embodiments and applications other than those detailed below without departing from the spirit and scope of the disclosed embodiments as defined herein. The disclosed embodiments are not intended to be limited to the particular embodiments shown, but are to be accorded the widest scope consistent with the principles and features disclosed herein.

The terms “couple” or “coupled” as used herein are intended to mean either an indirect or a direct connection. Thus, if a first device couples to a second device, that connection may be through a direct connection, or through an indirect electrical or mechanical connection via other devices and connections. The term “uphole” as used herein means along a drill string or a hole from a distal end towards the surface, and “downhole” as used herein means along the drill string or the hole from the surface towards the distal end.

It will be understood that the term “oil well drilling equipment” is not intended to limit the use of the equipment and processes described with those terms to drilling an oil well. The terms also encompass drilling natural gas wells or hydrocarbon wells in general. Further, such wells can be used for production, monitoring, or injection in relation to recovery of hydrocarbons or other materials from a subsurface. This could also include geothermal wells intended to provide a source of heat energy instead of hydrocarbons.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

For purposes of this disclosure, an information processing system may include any device or assembly of devices operable to compute, classify, process, transmit, receive, retrieve, originate, switch, store, display, manifest, detect, record, reproduce, handle, or utilize any form of information, intelligence, or data for business, scientific, control, or other purposes. Examples of well-known computing systems, environments, and/or configurations that may be suitable for use with the information processing system include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices or any other suitable device that may vary in size, shape, performance, functionality, and price.

The information processing system may include a variety of computer system readable media. Such media may be any available media that is accessible by the information processing system, and it includes both volatile and non-volatile media, removable and non-removable media. The information processing system can include computer system readable media in the form of volatile memory, such as random access memory (RAM) and/or cache memory. The information processing system may further include other removable/non-removable, volatile/non-volatile computer system storage media, one or more processing resources such as a central processing unit (“CPU”) or hardware or software control logic, and/or ROM. Additional components of the information processing system may include one or more network ports for communication with external devices as well as various input and output (“I/O”) devices, such as a keyboard, a mouse, and a video display.

The information processing system may also include one or more buses operable to transmit communications between the various hardware components. A first device may be communicatively coupled to a second device if it is connected to the second device through a wired or wireless communication network which permits the transmission of information.

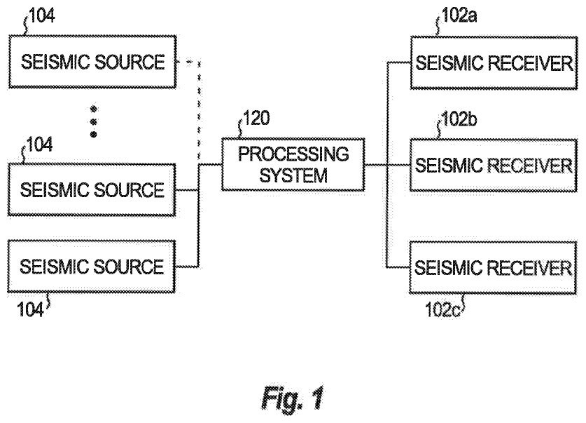

To facilitate a better understanding of the present disclosure, the following examples of certain embodiments are given. In no way should the following examples be read to limit, or define, the scope of the disclosure. Embodiments of the present disclosure and its advantages are best understood by referring to FIGS. 1-8, where like reference numbers are used to indicate like and corresponding parts.

Turning now to the drawings, FIG. 1 shows an illustrative example VSP system 100 according to the disclosed embodiments. The VSP system 100 can be used to analyze the earth's subsurface using a VSP survey, such as in association with a geophysical survey using oil well drilling equipment. The VSP system 100 can include a processing system 120, one or more seismic receivers 102 communicatively coupled to the processing system 120, and one or more seismic sources 104 that apply seismic energy to an underground formation at various offsets from a reference, such as a well head of the wellbore (referred to as walkaway VSP).

Each seismic source 104 (also termed a “shot”) is a device that generates controlled seismic energy and directs this energy into the underground formation. The seismic source 104 can generate seismic energy in a variety of ways, such as through an explosive device (e.g., dynamite or other explosive charge), an air gun, a “thumper truck,” a seismic vibrator, or other devices that can generate seismic energy in a controlled manner. Seismic sources 104 can provide single pulses of seismic energy or continuous sweeps of seismic energy. A single seismic source 104 can be used that is moved in incremental distances, applying seismic energy at the location of each distance increment. Alternatively, an array of seismic sources 104 can be positioned in the vicinity of an exploration site, such as a wellbore, wherein each seismic source 104 activates seismic energy from its respective position.

The seismic receiver 102 (such as a geophone or hydrophone or Distributed Acoustic Sensor) is a device used in seismic acquisition that detects ground velocity produced by seismic waves and transforms the motion into electrical impulses. Three seismic receivers 102 a-c are shown, referred to collectively as seismic receivers 102, without limitation to a specific number of seismic receivers. Seismic receiver 102 can detect motion in a variety of ways, for example through the use of an analog device (e.g., a sprint-mounted magnetic mass moving within a wire coil, or fiber optic cable detecting backscattered laser light) or a microelectromechanical (MEMS) device (e.g., a MEMS device that generates an electrical signal in response to ground motion) through an active feedback circuit). The seismic receivers 102 output VSP data that corresponds to the detected motion.

A processing system 120 includes at least one processor that communicates with seismic receivers 102 and seismic sources 104 in order to send and receive information (including VSP data) from seismic receivers 102 and seismic sources 104, and to control the operation of seismic receivers 102 and seismic sources 104. The various processors of the processing system 120 can have different tasks related to collecting data, processing the data, and controlling the seismic sources 104 and seismic receivers 102 a-c. These processors can be physically and/or functionally distributed, operating either independently or cooperatively.

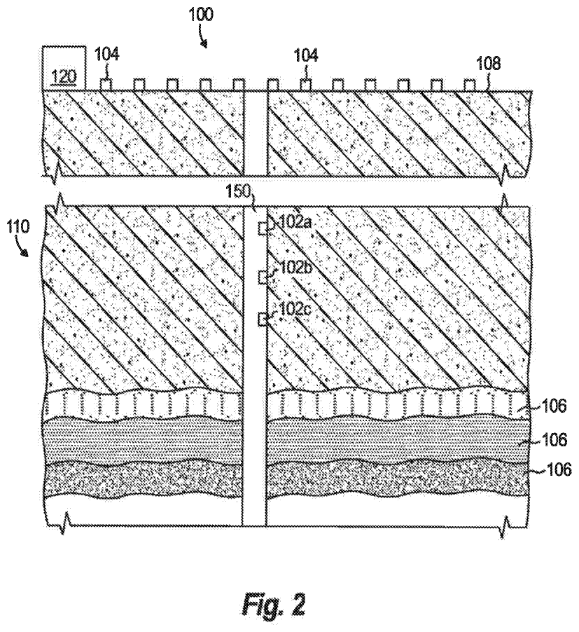

FIG. 2 shows an example physical arrangement for VSP system 100. As shown, seismic sources 104 are positioned in an array along the upper surface 108 of the subterranean formation 110, seismic receivers 102 a-c are positioned below the upper surface 108 within a wellbore 150. In some circumstances, subterranean formation 110 can be heterogeneous, and can include distributions of a variety of different media. The formation 110 can include at least one interface 106 between different media. Seismic energy generated by the seismic sources 104 travels through the subterranean formation 110. Some of this energy is reflected and/or refracted by features in subterranean formation 110 (e.g., reflected by the interface 106). The seismic receivers 102 can sense seismic/acoustic energy that originates from the seismic sources 104 and is reflected or refracted off of geologic features, e.g., interfaces 106, of the formation 110.

Time-dependent information (e.g., time-dependent seismic “traces”) can be obtained from VSP data output by each of the seismic receiver 102 a-c. Traces associated with a fixed lateral position in the solution space forming an image volume (the lateral position being called the image position, also referred to as the CIG location) can be “gathered” to form a common image gather (CIG).

The propagation of seismic energy through a medium and generation of resultant seismic traces is dependent on various factors. For example, the velocity of propagation can be dependent on the properties of the medium, such as the medium's density, elasticity, and depth below the surface. Thus, seismic energy directed into subterranean formation 110 can propagate differently depending on the composition of subterranean formation 110.

The travel time (or “arrival time”) of seismic energy can also depend on the locations of the seismic sources 104, seismic receivers 102, and interfaces 106. In an example, seismic energy from a single seismic source 104 may have different travel times to each of the seismic receivers 102 a-c, as each of the seismic receivers 102 a-c are located at a different depth below upper surface 108. In another example, seismic energy from different seismic sources 104 may have different travel times to each seismic receiver 102 a-c, as each seismic source 104 is located at a different point along the upper surface 108.

Seismic traces from each of the seismic receivers 102 a-c can be “migrated” based on information about the known or predicted properties of the subterranean formation 110. Migration is a process where each sample of an input seismic trace is mapped to an output image according to an image point within the subsurface. For example, seismic traces can be migrated by applying a velocity model that describes the behavior of seismic energy through the subterranean formation 110 based on known or predicted information about the composition of the subterranean formation 110.

If the velocity model used for migration is accurate, when seismic traces are migrated, reflection events in resulting pre-stack migrated output or common image gathers will be aligned properly, and a clear image of the subterranean formation can be created. However, if an inaccurate velocity model is used, the reflection events of the pre-stack, migrated output might not align, and the stacked image may be blurred or unclear. Seismic sources 104 and seismic receivers 102 a-c are communicatively connected to processing system 120 through a communication interface (such as telemetry as described below). An example communication interface includes, for example, wired connectors and/or wireless transceivers.

The example arrangement for VSP system 100 shown in FIG. 2 is not necessarily drawn to scale. In general, components of VSP system 100 can be placed according to various physical geometries in order to analyze the subterranean formation. In an example geometry, seismic sources 104 are positioned along the upper surface 108 of the subterranean formation 110, seismic receivers 102 a-c are positioned at depths of 1000 m, 1500 m, and 3000 m below upper surface 108, respectively, and interface 106 is located at a depth of 2700 m below upper surface 108. It will be understood, however, that the seismic receivers 102 a-c and the interface 106 can be disposed or located at other depths or positions. In this example, the upper surface 108 of the subterranean formation 110 is on the uppermost surface of the earth. However, in some implementations, upper surface 108 may be below the earth's uppermost surface. e.g. on the sea floor, disposed below the overburden, or the like.

Embodiments of the present disclosure may be applicable to horizontal, vertical, deviated, multilateral, u-tube connection, intersection, bypass (drill around a mid-depth stuck object and back into the wellbore below), or otherwise nonlinear wellbores in any type of subterranean formation. Certain embodiments may be applicable to, for example, wired drillpipe, coiled tubing (wired and unwired), logging data acquired with wireline, slickline, and logging while drilling/measurement while drilling (LWD/MWD). Certain embodiments may be applicable to subsea and/or deep sea wellbores. Embodiments described below with respect to one implementation are not intended to be limiting.

Modifications, additions, or omissions may be made to FIG. 2 without departing from the scope of the present disclosure. For example, the VSP system 100 may be used with wireline, Distributed Acoustics Sensing (DAS) VSP or slickline logging operations, including before the wellbore 150 is completed. Moreover, components may be added to or removed from the VSP system 100 without departing from the scope of the present disclosure.

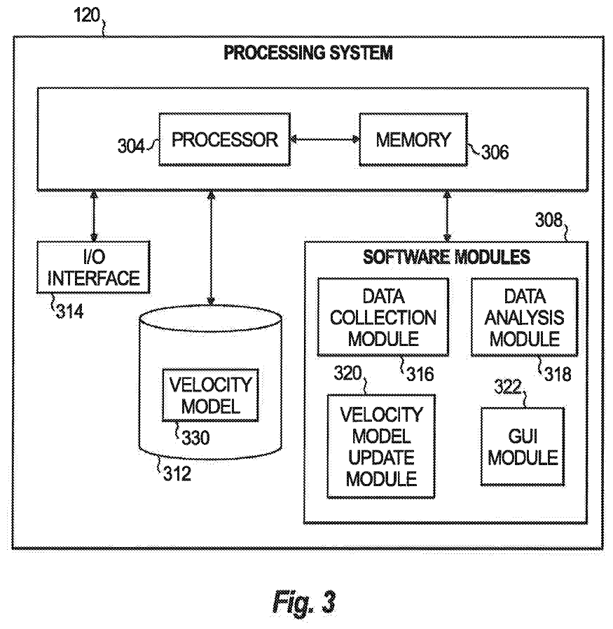

FIG. 3 illustrates a block diagram of an exemplary processing system 120, in accordance with embodiments of the present disclosure. The processing system 120 may be configured to receive VSP data from receivers (e.g., seismic receivers 102 shown in FIGS. 1 and 2). and analyze the VSP data, such as to perform one or more noise reduction methods, data quality evaluation methods, data migration methods, stacking methods, semblance construction methods, CIG update methods, velocity volume update methods, and image display methods. A portion of the processing system 120 can perform processing for VSP data collected by different drilling and logging systems, even when such drilling and logging systems are positioned at different locations.

The processing system 120 includes at least one processor 304. Processor 304 may include, for example a microprocessor, microcontroller, digital signal processor (DSP), application specific integrated circuit (ASIC), or any other digital or analog circuitry configured to interpret and/or execute program instructions and/or process data. As depicted, the processor 304 is communicatively coupled to at least one memory 306 and configured to interpret and/or execute program instructions stored in memory 306, and/or read and/or write data stored in memory 306. The program instructions may be included in one or more software modules 308, such as data collection module 316, data analysis module 318, velocity model update module 320, and GUI module 322.

Memory 306 may include any system. device, or apparatus configured to hold and/or house one or more memory modules; for example, memory 306 may include read-only memory, random access memory, solid state memory, or disk-based memory. Each memory module may include any system, device or apparatus configured to retain program instructions and/or data for a period of time (e.g., computer-readable non-transitory media). For example, instructions from the software modules 316, 318, 320, and 322 may be retrieved and stored in memory 306 for execution by processor 304.

In an embodiment of the present disclosure, data used or generated by the software modules 316, 318, 320, and 322, e.g., VSP data received from receivers 102, results of analysis of the VSP data, as well as one or more velocity models 430, etc., may be stored in database 312 for long-term storage. In certain embodiments, the processing system 120 may further include one or more displays or other input/output peripherals such that information processed by the processing system 120 can be displayed. such as graphical displays of 2D RMS velocity fields, semblance panels, CIGs, migrated pre-stack shot gathers, or images.

Processing system 120 can further include at least one communication port 314 to enable communication with external devices, e.g., networked devices or peripheral devices (e.g., input and output (“I/O”) devices, such as a keyboard, a mouse, and a video display). The processing system 120 can include a plurality of individual processing systems, e.g., that are networked to one another.

In embodiments, the processing system 120 can include different sub-processing systems that execute the data collection module 316 for collecting VSP data output by the receivers, the data analysis module 318, the velocity model update module 320, and the GUI module 322. The different sub-processing systems may be communicably coupled to at least another one of the sub-processing systems, through, for instance, a wired or wireless communication link. For example, a sub-processing system executing the data collection module 316 can be positioned at the upper surface 108 of the subterranean formation 110 proximate the wellbore 150, whereas one or more sub-processing systems executing the data analysis module 318, the velocity model update module 320, and the GUI module 322 can be located at one or more location that is remote from the wellbore 150. Two or more of the sub-processing systems can share components, e.g., processor 304, memory 306, database 312, and/or communication port 314, or include their own individual components.

In embodiments, the data received by the data collection module 316 can be simulated VSP data, which can be received, for example, from a simulator, external data center, or storage server that stores a library of VSP data.

Modifications, additions, or omissions may be made to FIG. 3 without departing from the scope of the present disclosure. For example, FIG. 3 shows a particular configuration of components of processing system 120. However, any suitable configurations of components may be used. For example, components of processing system 120 may be implemented either as physical or logical components. Furthermore, in some embodiments, functionality associated with components of processing system 120 may be implemented in special purpose circuits or components. In other embodiments, functionality associated with components of processing system 120 may be implemented in configurable general purpose circuits or components. For example, components of processing system 120 may be implemented by configured computer program instructions.

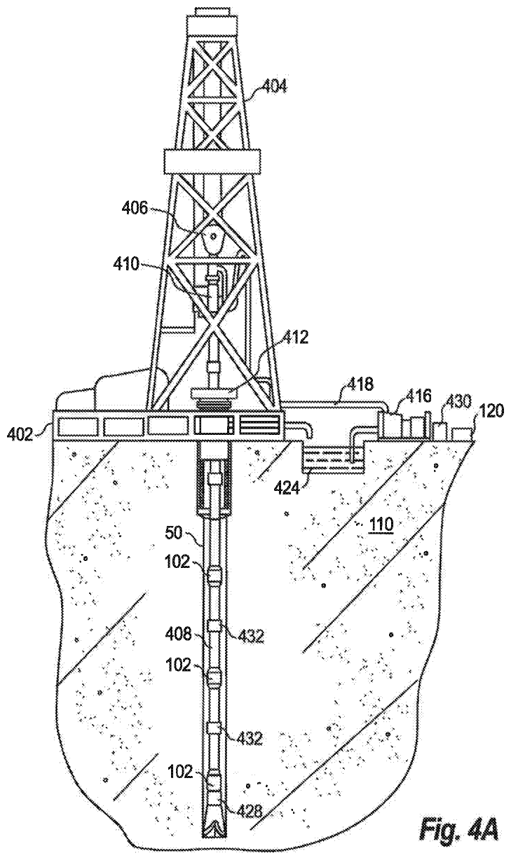

With reference to FIGS. 4A and 4B, examples of oil well drilling equipment and drilling environments with which the VSP system disclosed can be used are shown. FIG. 4A shows a suitable context for describing the operation of the disclosed systems and methods in an illustrated logging while drilling (LWD) environment. A drilling platform 402 is equipped with a derrick 404 that supports a hoist 406 for raising and lowering a drill string 408. The hoist 406 suspends a top drive 410 that rotates the drill string 408 as it is lowered through a well head 412. Connected to the lower end of the drill string 408 may be a drill bit (not shown) that rotates, such as to create the wellbore 150 that passes through the formation 110. A bottomhole assembly (BHA) (not shown) may be provided near the drill bit to collect data.

A pump 416 circulates drilling fluid through a supply pipe 418 to top drive 410, through the interior of drill string 408, through orifices in the drill bit, back to the surface, and into a retention pit 424. The drilling fluid transports cuttings from the wellbore 150 into the pit 424 and aids in maintaining the integrity of the wellbore 150. Drilling fluid, often referred to in the industry as “mud,” is often categorized as either water-based or oil-based, depending on the solvent.

Data from the seismic receivers 102 can be transmitted using various forms of telemetry used in drilling operations. Seismic receivers 102 can be coupled to a telemetry module 428 that can transmit telemetry signals. These telemetry signals can be transmitted to a receiving device 430 at the surface 108 of wellbore 150. The receiving device 430 can be incorporated in or in communication with the processing system 120 to provide the telemetry signals to the processing system 120. The transmission of the telemetry signals can be performed by one or more devices, such as a downhole receiver that receives the telemetry signals output by the telemetry module 428 and/or downhole repeaters that receive and retransmit the telemetry signals until they can be received by the receiving device 430 at the surface 108 of the wellbore 150.

For example, the telemetry module 428 can include an acoustic telemetry transmitter that transmits telemetry signals in the form of acoustic vibrations in the tubing wall of drill string 408. The downhole receiver can be coupled to tubing below the top drive 410 to receive transmitted telemetry signals. The downhole repeaters can include one or more repeater modules 432 that can be optionally provided along the drill string 408 to receive and retransmit the telemetry signals. Other telemetry techniques can be employed, including mud pulse telemetry, electromagnetic telemetry, and wired drill pipe telemetry. In some embodiments, the telemetry module 428 also or alternatively stores VSP data output by the seismic receivers 102 for later retrieval when the telemetry module 428 is returned to the surface 108 of the wellbore 150.

FIG. 4B shows another suitable context for describing the operation of the disclosed systems and methods in which a wireline configuration is used. Logging operations can then be conducted using a wireline logging tool 450, e.g., a sonde sensing instrument, suspended by a cable 456. The cable 456 can include conductors for transporting power to the tool 450 and/or communications from the tool 450 to the surface of the wellbore 150. A logging portion of the wireline logging tool 450 may have centralizing arms 452 that center the tool 450 within the wellbore 150 as the tool 450 is pulled uphole. In certain embodiments, the seismic receivers 102 can be mounted to cable 456 and lowered into the wellbore 150. In other embodiments, the receivers 102 can be channels from a DAS fiber optic recording system.

As in the LWD environment shown in FIG. 4A, telemetry can be used to provide data output by the seismic receivers 102 to the processing system 120. The seismic receivers 102 can be coupled to telemetry module 428, so that telemetry signals can be transmitted from the seismic receivers 102 via one or more repeater modules 432 and/or a downhole receiver (not shown) to the receiving device 430 at the surface 108 of wellbore 150.

A logging facility 460 collects measurements from the wireline logging tool 450, and includes computing facilities 462 that can include receiving device 430 for receiving the telemetric signals and/or processing system 120 for processing and storing VSP data output by seismic receivers 102.

With returned reference to FIGS. 2 and 3, the processing system 120 can perform an analysis on VSP data output by the seismic receivers 102 and generate common images (also referred to as a VSP images) using an initial velocity model 330. The velocity model 330 models velocity of energy propagation across the formation 110. An inaccurate velocity model 330 causes distortion, such as blurring, in VSP images rendered by the processing system 120 using the velocity model 330. The velocity model 330 can be iteratively updated to improve its accuracy and the clarity of the VSP images.

At first the VSP data is commonly imaged using an initial velocity model, wherein the initial velocity model 330 can be derived from surface seismic data, sonic logs and other processed VSP data. The velocity model 330 is iteratively updated using a non-tomographic approach in the post-migration domain. In an example embodiment, an isotropic earth is assumed, with low dependence on subsurface structure for velocity analysis. Updates to the velocity model 330 are performed initially by selecting migration velocity ratios that maximize the flatness of reflection events in CIGs which will be stacked together to create the final VSP image.

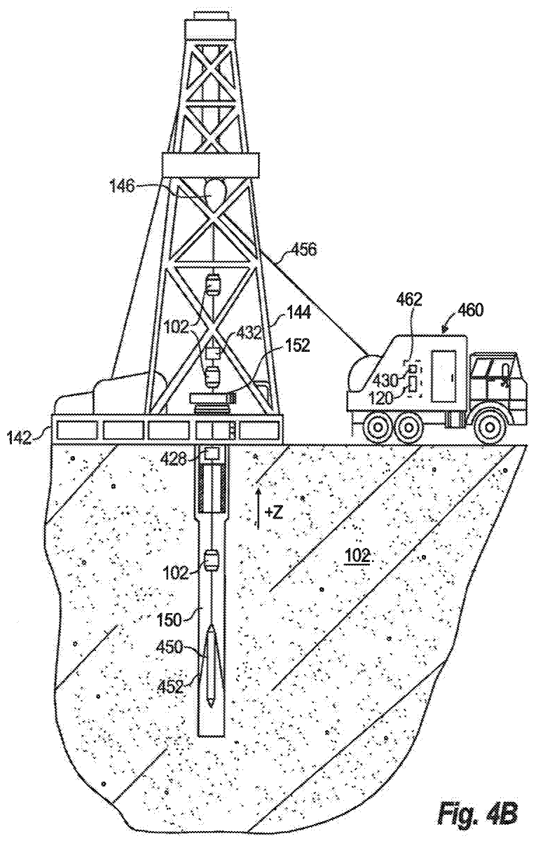

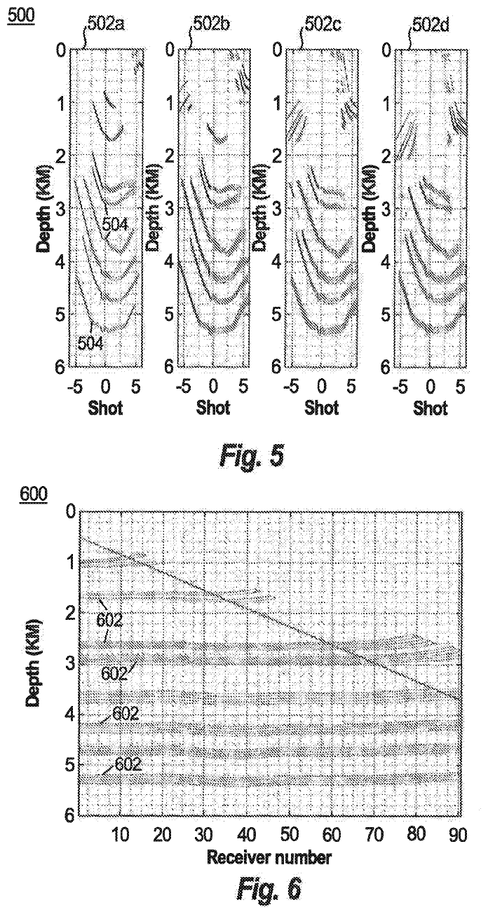

The method of iteratively updating the velocity model includes receiving and migrating VSP data. Migrated VSP traces that corresponds to each shot from the same receiver are sorted and collected, forming a migrated common receiver gather (CRG) (e.g., as in migrated CRGs 502a, 502b, 502c, and 502d shown in FIG. 5). Seismic traces of migrated CRG are stacked together so that each migrated CRG forms one CIG trace in a CIG (e.g., as in CIG 600 shown in FIG. 6). The CIG traces are stacked to generate a migrated VSP image, each stacked CIG trace corresponding to a CIG location.

As explained above, the CIG location is a location on the horizontal plane that defines the horizontal coordinates (x and y) of the stacked image volume. This horizontal plane may define the surface of the earth, or some alternative datum may be chosen. In the two dimensional case, the three dimensional volume reduces to a single plane defined by x and z axes, respectively, in the Cartesian coordinate system, though other coordinate systems may be used. The location (x,y) of this CIG is called its CIG location.

The velocity model 330 is then adjusted by selecting velocity ratios at corresponding true depth values that optimize observed flatness of reflection events in the CIGs. In certain embodiments, the flatness of reflection events in CIGs are adjusted in a structurally independent fashion and applied to a subsurface model of the formation 110 without an underlying structural constraint, for example a layer cake structure. In other embodiments, lateral constraints can be used, such as by grouping lateral velocity updates to be within a layer-wise set of boundaries or horizon. The process is repeated at each CIG location of the VSP image.

The method used for updating the velocity model 330 is based on a principle that when an accurate velocity model is used, subsurface points in the formation 110 depicted in the VSP image would be determined to be at the same depth using VSP data output by each of the seismic receivers 102 that detected reflections associated with that point, producing a clear image. Reflection events in a CIG that correspond to image depths for that point versus locations of various seismic receivers 102 would be flat. On the other hand, when a wrong velocity model is used, the image depths of the point would not be the same, producing a blurred image. The CIG plot of the image depths for that point versus various seismic receivers 102 would be non-flat.

FIG. 5 shows a screenshot 500 of four migrated CRGs 502a-502d (also referred to collectively or individually as 502), that correspond to one CIG location based on migrated, unstacked VSP data output by four different respective seismic receivers at increasing depths.

The migrated pre-stack data is also referred to as M(s,g,z), describing a volume at each CIG location after migration, where s is the offset of the seismic source (shot) along the x-axis (e.g., relative to the well head), g represents a geophone location (along the z-axis, e.g., relative to the well head), and z is depth. In FIG. 5, the vertical axis represents migration depth (z) and the horizontal axis represents the shot offset along the x axis (s). An example migration algorithm is the Kirchhoff migration algorithm. Alternative migration algorithms include, for example, reverse time migration and Gaussian beam migration.

Each CRG 502 is associated with a particular seismic receiver 102 positioned at a unique depth z relative to the well head. Each CRG 502 includes CRG reflection events in the M(s,z) domain. More particularly, the four CRGs 502 shown have different respective g values of an M(s,g,z) volume associated with the CIG location. The migration process further includes sorting and collecting the migrated depth values, including mapping the VSP data to the (s,g,z) space for each lateral position in the image space. This means a CRG corresponding to a particular receiver location defined by ‘g’ in the (s,g,z) space is obtained by collecting all the data points in the (s,z) plane for that value of ‘g’ at that lateral position within the image space. The image space may be a plane or volume depending on the type of survey and objectives of the VSP survey.

In the example shown, the screenshot 500 shows four migrated CRGs that correspond to four different seismic receivers, however a different number N of migrated CRGs can be accessed, such as by scrolling through displayable data, each migrated CRG corresponding to a different seismic receiver of N seismic receivers. Additionally, the view shown in the screenshot 500 can be adjusted by a user to show more or less CRGs 502 at a time, and to navigate through multiple CRGs 502.

FIG. 6 shows a screenshot of an example CIG 600 with reflection events (reflected energy) 602 placed side-by-side, sorted by receiver depth or receiver number. In the example shown, the horizontal axis of CIG 600 represents the receiver number, which increases in correspondence to increasing receiver depth, and the vertical axis represents the migration depth.

The CIG 600 is calculated using the velocity model 330 for migrating the VSP data. The disclosure is not limited to the number of CG reflection events 602 or number of CIG traces in each CIG 600, as the CIG 600 is provided for illustrative purposes only. The view shown in the CIG 600 can be adjusted by a user to show more or fewer CIG traces in each CIG 600 at a time, and to navigate through multiple CIGs 600.

The CIG reflection events 602 form CIG traces that correlate with M(g,z) as obtained from M(s,g,z) after stacking along the shot (s) axis with the shot location selection restrictions described below. Each CIG trace in CIG 600 corresponds to a receiver number positioned at the actual physical depth for that receiver, with the vertical axis corresponding to migrated depth, Zmig.

In other words, for each location at which seismic energy was applied by a seismic source 104 (also referred to as a shot location), at each CIG location, the processing system 120 can generate a CIG in the M(g,z) domain. The CIG 600 is generated by stacking pre-stacked data in the M(s,g,z) domain along the shot axis of the seismic source 104 at the offset s of the seismic source 104 using a migration algorithm. Shot locations used for the stacked CIGs are selected on the basis of a neighborhood defined in the vicinity of the CIG location under consideration. For example, shot locations that are located on another side of the well head relative to the CIG location under consideration are avoided in the computation. The stacked traces that correspond to each individual CIG produce a partial image that corresponds to each receiver at the same CIG location.

CIG 600 corresponds to a single CIG location. Subsequent rounds of stacking along the g axis can be performed to obtain a fully stacked image trace in the M(z) domain for that CIG location. A VSP image can be generated by repeating this type of stacking for each CIG location within a 2D profile of the image domain (also referred to as the image space). This process can also be repeated for three dimensional CIG locations to generate a 3D image volume.

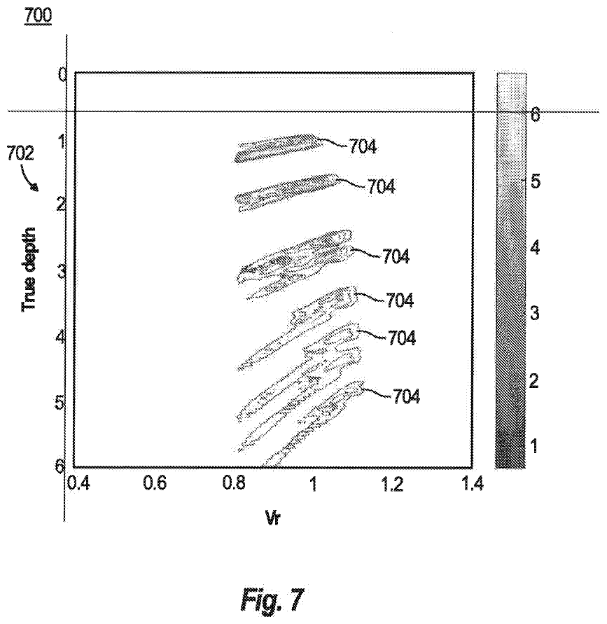

FIG. 7 shows a screenshot 700 of an example semblance panel 702 for a particular CIG location. The semblance panel 702 includes contours 704, in which the semblance of the stacked data M(g,z) are plotted using vr (along a horizontal axis) versus Zt (km) (along a vertical axis), where vr is the velocity ratio and Zt is true depth, as described in greater detail below. Each contour 704 is formed of points that correspond to equal semblance values of corresponding amplitudes of stacking the migrated data along new migration trajectories. The M(g,z) data is stacked based on Z_{mig} to form contours 704, where Z_{mig} is determined as a function of (Zₜ, vᵣ, s, g, b), v_{mig} is migration velocity up to a depth in the subsurface, vₜ is true velocity up to the same depth, t is travel time, in the 2D plane in which the survey is conducted, and b is the CIG x-axis location (e.g., relative to the well head) in the 2D plane.

The CIG x-axis locations are positions within the survey area at which local images are desired. The survey area is defined by shot locations from which the sources have been fired to apply seismic energy. For two-dimensional modelling, the x-axis defining shot locations and the x-axis defining the CIG x-locations coincide. When three-dimensional modelling is implemented, these x-axes may be rotated with respect to each other. Reflection energy associated with each CIG location depends on the locations of the shots and receivers. Accordingly, a CIG location within the survey area may not have adequate reflection energy because the receiver positions do not provide such energy for that particular CIG location.

In embodiments, P is determined as a function of (Zₜ, vᵣ, s, g), where P is the major axis of a common receiver gather migration ellipse, which is equal to migration velocity v_{mig} multiplied by travel time t.

In embodiments, the semblance panel can be determined using equations (1)-(5), as shown below. Equations (1)-(4) are disclosed in Du, Y., Willis, M. E, and Stewart, R. R., Vertical Seismic Profile Migration Velocity Analysis Via Residual Moveout In Receiver Domain Common Image Gathers, Geophysics, Society of Exploration Geophysicists, 80 (5), 1-16, 2015.

$$\begin{matrix}{Z}_{mig} = \frac{\frac{gs ( s - 2 b )}{2} + \frac{P}{2} \sqrt{{P}^{2} - ( {s}^{2} + {g}^{2} )} \sqrt{{P}^{2} - {( s - 2 b )}^{2} - {g}^{2}}}{{P}^{2} - {g}^{2}} + \frac{g}{2} & ( 1 ) \\ P = {v}_{mig} * t & ( 2 ) \\ t = \frac{\sqrt{{( 2 {Z}_{t} - g )}^{2} + {s}^{2}}}{{v}_{t}} & ( 3 ) \\ {v}_{r} = \frac{{v}_{mig}}{{v}_{t}} & ( 4 ) \\ panel ( {Z}_{t} , {v}_{r} ) = \frac{{[ {\sum }_{g} M ( {Z}_{mig} \cdot g ) ]}^{2}}{{\sum }_{g} [ M ( {Z}_{mig} \cdot g ) ]} & ( 5 )\end{matrix}$$

Z_{mig} is computed for each pair (vᵣ, Zₜ) for various sources at offset s and receivers at depth g, using equations (1)-(4), which are not dependent on the data itself, but are theoretical curves. Extrema of theoretical s-Zmig curves are calculated to determine a reflection point Zmig for different seismic receivers. This is performed by numerically finding the point where the derivative of the theoretical curve changes sign, using selected source offsets that are in a predefined neighborhood of the CIG location. Data points from the stacked M(g,z) that correspond to the extrema are selected from the theoretically predicted (s-Zmig) curves. This process creates a list of Zmig values for each receiver, which defines a stacking trajectory. The data values from the corresponding migrated depths of each CIG trace, corresponding to the list of Zmig values for each receiver, are stacked using Equation (5) to generate the semblance panel. In an embodiment, only VSP data output by seismic receivers that are positioned above the depth point Zt are included when stacking to compute semblance.

The first set of contours 704 are calculated using the initial velocity model 330. The disclosure is not limited to the number contours 704 shown in the screenshot 700, as the screenshot 700 is provided for illustrative purposes only. The view shown in the screenshot 700 can be adjusted by a user to show more or less contours 704 at a time, and to navigate through multiple contours 704.

A user knowledgeable about VSP studies can view screenshots 600 and 700 (and optionally 500). The user is provided with a user input interface, such as a graphical user interface (GUI) provided by the GUI module 322 (as shown in FIG. 3). The GUI can be operated by the user to select discrete (Zₜ, vᵣ) points displayed on the semblance panel 702.

Once at least three discrete (Zₜ, vᵣ) points are selected for those reflection events that are to be optimized, a smooth curve is generated that passes through those discrete points. This curve is depth sampled at the same depth interval as the migrated traces at the corresponding CIG location displayed in screenshot 600. The migration interval velocity model for this CIG location is converted to a migration root mean squared (RMS) velocity curve, Vrms, sampled at the same depth interval, using for example the methods disclosed by Sheriff, R. E., et al., Exploration Seismology, Cambridge University Press, 1995, among others. The original migration RMS velocities are divided by vᵣ at every depth sample to update the RMS velocity curve. Updated RMS velocities curves at multiple CIG locations are interpolated and converted to interval velocities to generate an updated 2D and/or 3D interval velocity model 330. This process of migrating data and updating the velocity model 330 can be repeated in multiple iterations until satisfactory flatness of the CIG reflection events 602 are obtained, and an optimal VSP image is found.

More particularly, when updating the velocity model 330, a location selected on the semblance panel 702 has corresponding coordinates (vr, Zt). The values for vr and Zt, as selected by the user, can be used to update the velocity model and re-migrate the VSP data, such as to generate new updated versions of the CRG 502, CIG 600, and final VSP images. The velocity updating process is begun again with these new migrated data sets. The user can visually inspect the updated CIGs 600 and contours 702 (and optionally CRG 502) to determine whether the updated velocity model 330 has improved or declined in accuracy. Additionally, the visual inspection can be used to determine whether further attempts can or should be made to improve the velocity model 330.

A combination of one or more criteria can be used to ascertain whether the velocity model 330 used for migration is accurate. One measure of accuracy is flatness of the CIG reflection events 602 on the CIGs 600, indicating that CIG reflection events 602 are aligned since they have a common depth. Another measure of accuracy is complexity of the CIGs 600, wherein an inaccurate velocity model 330 that applies a velocity which is too fast may cause degradation of the CIGs 600. The degradation of the CIGs 600 can be determined, for instance by computing a coherency measure of the migrated traces. The semblance value will decrease significantly when the complexity increases and the alignment is poor. A further measure of accuracy is indicated by alignment or shape, e.g., curvature (such as, concave, convex, complex), of the CRG reflection events 504 in the CRG gathers 502.

Another measure of accuracy is alignment of the contours 704 of the semblance panel 702. Alignment of centers of the contours 704 over vr=1 indicates a highly accurate velocity model, whereas a lack of alignment or alignment over a different value vr indicates lower accuracy. Additionally, a coherent contour displayed with high amplitude indicates a highly accurate velocity model, whereas a contour that is bifurcated, polygonal, and/or displayed with low amplitude indicates lower accuracy.

The process of selecting points on the semblance panel 702, updating the velocity model, re-migrating the VSP data, and generating and displaying updated CIGs can be repeated at different CIG locations until the updated velocity model is determined to be sufficiently accurate.

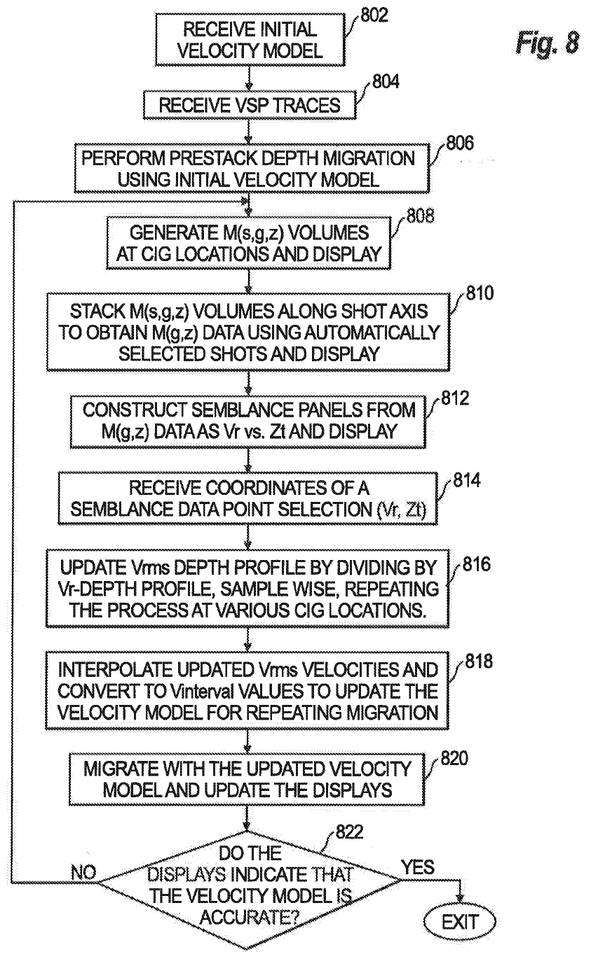

With reference now to FIG. 8, shown is a flowchart demonstrating implementation of an exemplary embodiment of a method of the disclosure. It is noted that the order of operations shown in FIG. 8 is not required, so in principle, the various operations may be performed out of the illustrated order. Also certain operations may be skipped, different operations may be added or substituted, or selected operations or groups of operations may be performed in a separate application following the embodiments described herein. The operations shown in FIG. 8 can be performed by the processing system 120 shown in FIGS. 2, 3, 4A, and 4B. In particular, the processing system 120 may execute one or mom of the software modules 308, causing the processing system 120 to perform the operations shown in the flowchart and described in the disclosure.

At operation 802, an initial velocity model is received, which can be based upon known or estimated velocity information about a region being examined. The term “receive” herein can refer to receiving a transmission, retrieving, obtaining, or accessing. At operation 804, un-migrated VSP data that includes pre-stack VSP traces is received. The VSP data can be data that was output by receivers during a VSP survey, simulated data, or stored data, such as from a library of VSP data.

At operation 806, pre-stack depth migration is performed on the VSP traces using the initial velocity model. At operation 808, migrated VSP traces that correspond to each shot from the same receiver are combined and saved into a first data set (also referred to as M(s,g,z) volumes). The M(s,g,z,) volumes are optionally displayed as CRGs, each CRG corresponding to a receiver, and having a horizontal axis that indicates source offset (shot) and a vertical axis that indicates migrated depth (Zmig). The CRGs include CRG reflection events in the M(s,z) domain.

At operation 810, the CRGs are stacked along the shot axis for each CIG location, using automatically selected shots, to generate a second data set (also referred to as a M(g,z) volume) of CIGs. The second data set is displayed in a CIG plot, having a horizontal axis that indicates receiver number and a vertical axis that indicates Zmig, wherein the receiver number identifies the individual receivers. The shots can be selected based on a neighborhood defined in the vicinity of the CIG location under consideration.

At operation 812, a semblance panel is constructed from the M(g,z) volume and displayed in a plot having a horizontal axis that indicates that indicates velocity ratio (vr) having and a vertical axis that indicates true depth (Zt). At operation 814, selected (vr, Zt) coordinates of data points selected on the semblance panel are received. At operation 816, Vrms velocities of the current velocity model are updated by dividing the Vrms profile by the interpolated vr-Zt profile, sample-wise. The process of updating the Vrms velocity curves is repeated at different CIG locations.

At operation 818, the updated Vrms velocities are interpolated and converted into interval velocities to update the velocity model with updated 2D or 3D interval velocity profiles. At operation 820, migration of the VSP data is repeated using the updated velocity model, and the displays of the pre-stack migrated traces, the stacked traces, and/or the contours of the semblance panel are updated with the re-migrated data.

At operation 822, a determination is made whether the updated displays of the pre-stack migrated traces, the stacked traces, and/or the contours of the semblance panel indicate that the accuracy of the velocity model is acceptable. The determination can be a human determination or can include an automated determination of image quality. The automated process could, for example, use the progressive increase in the value of the semblance selections as a test to determine whether the quality of the resulting stack has stopped improving. If the accuracy of the velocity model is determined at operation 822 to be satisfactory, the method ends. If the accuracy of the velocity model is determined at operation 822 to be unsatisfactory, the method continues at operation 808.

In embodiments, data collection operations are performed by data collection module 316, data analysis operations are performed by the data analysis module 318, velocity model updating of operations are performed by the velocity model update module 320, graphical displays of the M(s,g,z) volumes, M(g,z) volumes, and semblance panels, updating the displays, and receipt of the data point selection are performed by the GUI module 322 shown in FIG. 3.

Accordingly, in accordance with aspects of the disclosure, a method is provided to process VSP data using depth migration. The method includes receiving VSP data output by a plurality of receivers positioned at different depths of a wellbore in response to seismic energy application at a plurality of offsets relative to a well head of the wellbore based on a walkaway VSP survey and migrate the VSP data output by the respective receivers using an initial velocity model to produce migrated depth values associated with the respective receivers.

The method further includes sorting and collecting the migrated depth values corresponding to each receiver to produce a migrated CRG associated with each receiver; stacking the migrated depth values of the CRGs corresponding to respective fixed lateral positions in an image volume to produce a CIG associated with each lateral position, and generating a semblance panel having the stacked depth migration values plotted as contours on a first axis for velocity ratio (vr) and a second axis for true depth (Zt). The velocity ratio is based on migration velocity and true velocity. The method further includes updating the initial velocity model based on a plurality of data points selected from the semblance panel to provide an updated velocity model.

In embodiments, the method can further include re-migrating the VSP data using the updated velocity model.

In embodiments, the method can further include updating the stacked migration depth values using the re-migrated VSP data.

In embodiments, the method can further include updating and stacking the CIGs and updating the semblance panel, including determining Zmig for pairs (vᵣ, Zₜ) at depths g of respective receivers for respective offsets s, wherein Zmig is a function of g, s, b, and P, b is respective CIG x-axis locations in a 2D plane, P is a function of the migration velocity and travel time of the seismic energy from the respective offsets to the respective receivers, travel time is a function of Zt, g, s, and vt, and vr is determined as a function of vmig and vt. The semblance panel is generated as panel (Zₜ, vᵣ), wherein panel (Zₜ, vᵣ) is a function of, Σ_{g}M(Z_{mig},g).

In embodiments, the method can further include providing a plot of CIGs based on the updated, migrated, and stacked CRGs and the semblance panel as updated to be displayed to a user via a GUI.

In embodiments, the displayed plot of CIGs and the semblance panel can indicate a degree of accuracy of the velocity model, and the method can further include iteratively receiving data points selected from the semblance panel, updating the velocity model using the received data points, re-migrating the VSP data using the updated velocity model, updating the stacked migration depth values using the re-migrated VSP data, and updating the semblance panel using the updated, stacked depth migration depth values.

In embodiments, the method can further include receiving the plurality of data points via the GUI.

In embodiments, the method can further include providing plots of the re-migrated VSP data.

In embodiments, the migration depth values can be determined as a function of (Zₜ, vᵣ, s, g, b), wherein where Z is true depth along a z-axis, s an offset of the source along an x-axis location relative to a well head of the wellbore, and b is the CIG location along the x-axis location relative to the well head.

In embodiments, the plurality of selected data points can be discrete data points, and the method can further include generating a smooth curve that passes through the selected data points, depth sampling the curve, and updating RMS velocities of an original RMS velocity curve associated with the initial velocity model using vr determined from each depth sample.

In embodiments, the method can further include interpolating the RMS velocity curves associated with multiple CIG locations, converting the RMS velocity curves to interval velocities, and updating a 2D or 3D interval velocity profile of the velocity model using the interval velocities.

In accordance with further aspects of the disclosure, a VSP system is provided. The system includes at least one seismic energy source applying seismic energy to a formation undergoing a VSP survey and a plurality of receivers disposed below a surface of the formation to output VSP data in response to detecting seismic energy associated with the applied seismic energy. The system further includes a processing system including at least one processor and a memory coupled to the processor, wherein the memory stores programmable instructions.

When executed by the processor, the programmable instructions cause the processor to receive VSP data output by a plurality of receivers positioned at different depths of a wellbore in response to seismic energy application at a plurality of offsets relative to a well head of the wellbore based on a walkaway VSP survey, migrate the VSP data output by the respective receivers using an initial velocity model to produce migrated depth values associated with the respective receivers; sort and collect the migrated depth values corresponding to each receiver to produce a migrated CRG associated with each receiver; stack the migrated depth values of the CRGs corresponding to respective fixed lateral positions in an image volume to produce a CIG associated with each lateral position, generate a semblance panel having the stacked depth migration values plotted as contours on a first axis for velocity ratio (vr), wherein the velocity ratio is based on migration velocity and true velocity, and a second axis for true depth (Zt). The, initial velocity model is updated based on a plurality of data point selected from the semblance panel to provide an updated velocity model.

In embodiments, the programmable instructions can further cause the processor to re-migrating the VSP data using the updated velocity model. In embodiments, the programmable instructions can further cause the processor to update the stacked migration depth values using the re-migrated VSP data. In embodiments, the programmable instructions can further cause the processor to update the semblance panel using the updated, stacked depth migration depth values.

In accordance with further aspects of the disclosure, a computer system having a processor and a memory is provided. The memory is memory coupled to the processor, wherein the memory stores programmable instructions, that when executed by the processor, cause the processor to receive VSP data output by a plurality of receivers positioned at different depths of a wellbore in response to seismic energy application at a plurality of offsets relative to a well head of the wellbore based on a walkaway VSP survey, migrate the VSP data output by the respective receivers using an initial velocity model to produce migrated depth values associated with the respective receivers, sort and collect the migrated depth values corresponding to each receiver to produce a migrated common receiver gather (CRG) associated with each receiver and stack the migrated depth values of the CRGs corresponding to respective fixed lateral positions in an image volume to produce a common image gather (CIG) associated with each lateral position. In addition, the programmable instructions, when executed by the processor, cause the processor to generate a semblance panel having the stacked depth migration values plotted as contours on a first axis for velocity ratio (vr), wherein the velocity ratio is based on migration velocity and true velocity, and a second axis for true depth (Zt). Furthermore, the programmable instructions, when executed by the processor, cause the processor to update the initial velocity model based on a plurality of data point selected from the semblance panel to provide an updated velocity model.

In embodiments, the programmable instructions can further cause the processor to re-migrate the VSP data using the updated velocity model. In embodiments, the programmable instructions can further cause the processor to update the stacked migration depth values using the re-migrated VSP data and update the semblance panel using the updated, stacked depth migration depth values.

In accordance with further aspects of the disclosure a non-transitory computer-readable medium storing instructions is provided. When executed by a processor, the instructions cause the processor to receive VSP data output by a plurality of receivers positioned at different depths of a wellbore in response to seismic energy application at a plurality of offsets relative to a well head of the wellbore based on a walkaway VSP survey, migrate the VSP data output by the respective receivers using an initial velocity model to produce migrated depth values associated with the respective receivers, sort and collect the migrated depth values corresponding to each receiver to produce a migrated common receiver gather (CRG) associated with each receiver and stack the migrated depth values of the CRGs corresponding to respective fixed lateral positions in an image volume to produce a common image gather (CIG) associated with each lateral position. In addition, the programmable instructions, when executed by the processor, cause the processor to generate a semblance panel having the stacked depth migration values plotted as contours on a first axis for velocity ratio (vr), wherein the velocity ratio is based on migration velocity and true velocity, and a second axis for true depth (Zt), and update the initial velocity model based on a plurality of data point selected from the semblance panel to provide an updated velocity model.

In embodiments, the instructions, when executed, can further cause the processor to re-migrate the VSP data using the updated velocity model.

While particular aspects, implementations, and applications of the present disclosure have been illustrated and described, it is to be understood that the present disclosure is not limited to the precise construction and compositions disclosed herein and that various modifications, changes, and variations may be apparent from the foregoing descriptions without departing from the spirit and scope of the disclosed embodiments as defined in the appended claims.

1. A method, implemented by a computer, of processing vertical seismic profile (VSP) data using depth migration comprising:
receiving VSP data output by a plurality of receivers positioned at different depths of a wellbore in response to seismic energy application at a plurality of offsets relative to a well head of the wellbore based on a walkaway VSP survey;
migrating the VSP data output by the respective receivers using an initial velocity model to produce migrated depth values associated with the respective receivers;
sorting and collecting the migrated depth values corresponding to each receiver to produce a migrated common receiver gather (CRG) associated with each receiver;
stacking the migrated depth values of the CRGs corresponding to respective fixed lateral positions in an image volume to produce a common image gather (CIG) associated with each lateral position;
generating a semblance panel having the stacked depth migration values plotted as contours on a first axis for velocity ratio (vr), wherein the velocity ratio is based on migration velocity and true velocity, and a second axis for true depth (Zt); and
updating the initial velocity model based on a plurality of data points selected from the semblance panel to provide an updated velocity model.

2. The method of claim 1, further comprising re-migrating the VSP data using the updated velocity model.

3. The method of claim 2, further comprising updating the stacked migration depth values using the re-migrated VSP data.

4. The method of claim 3, further comprising updating and stacking the CIGs and updating the semblance panel, including determining Zmig for pairs (vᵣ, Zₜ) at depths g of respective receivers for respective offsets s, Zmig being a function of g, s, b, and P, wherein b is respective CIG x-axis locations in a 2D plane, P is a function of the migration velocity and travel time of the seismic energy from the respective offsets to the respective receivers, the travel time being determined as a function of Zt, g, s, and vt, vr is determined as a function of vmig and vt, and the semblance panel is generated as panel(Zₜ, vᵣ), wherein panel (Zₜ, vᵣ) is a function of Σ_{g}M(Z_{mig}, g).

5. The method of claim 4, further comprising providing a plot of CIGs based on updated, migrated, and stacked CRGs and the semblance panel as updated to be displayed to a user via a graphical user interface (GUI).

6. The method of claim 5, wherein the displayed plot of CIGs and the semblance panel indicate a degree of accuracy of the velocity model, and the method further comprises iteratively receiving data points selected from the semblance panel, updating the velocity model using the received data points, re-migrating the VSP data using the updated velocity model, updating the stacked migration depth values using the re-migrated VSP data, and updating the semblance panel using the updated, stacked depth migration depth values.

7. The method of claim 5, further comprising receiving the plurality of data points via the GUI.

8. The method of claim 5, further comprising providing plots of the re-migrated VSP data.

9. The method of claim 5, wherein the migration depth values are determined as a function of (Zₜ, vᵣ, s, g, b), wherein where Zt is true depth along a z-axis, s an offset of the source along an x-axis location relative to a well head of the wellbore, and b is the CIG location along the x-axis location relative to the well head.

10. The method of claim 5, wherein the plurality of selected data points are discrete data points, and the method further comprises:
generating a smooth curve that passes through the selected data points;
depth sampling the curve; and
updating RMS velocities of an original RMS velocity curve associated with the initial velocity model using vr determined from each depth sample.

11. The method of claim 10, further comprising:
interpolating the RMS velocity curves associated with multiple CIG locations;
converting the RMS velocity curves to interval velocities; and
updating a 2D or 3D interval velocity profile of the velocity model using the interval velocities.

12. A vertical seismic profiling (VSP) system, comprising:
at least one seismic energy source configured to apply seismic energy to a formation undergoing a VSP survey;
a plurality of receivers disposed below a surface of the formation to output VSP data in response to detecting seismic energy associated with the applied seismic energy; and
a processing system including:
at least one processor; and
a memory coupled to the processor, wherein the memory stores programmable instructions, that when executed by the processor, cause the processor to:
receive VSP data output by a plurality of receivers positioned at different depths of a wellbore in response to seismic energy application at a plurality of offsets relative to a well head of the wellbore based on a walkaway VSP survey;
migrate the VSP data output by the respective receivers using an initial velocity model to produce migrated depth values associated with the respective receivers;
sort and collect the migrated depth values corresponding to each receiver to produce a migrated common receiver gather (CRG) associated with each receiver;
stack the migrated depth values of the CRGs corresponding to respective fixed lateral positions in an image volume to produce a common image gather (CIG) associated with each lateral position;
generate a semblance panel having the stacked depth migration values plotted as contours on a first axis for velocity ratio (vr), wherein the velocity ratio is based on migration velocity and true velocity, and a second axis for true depth (Zt); and
update the initial velocity model based on a plurality of data point selected from the semblance panel to provide an updated velocity model.

13. The VSP system of claim 12, wherein the programmable instructions further cause the processor to re-migrate the VSP data using the updated velocity model.

14. The VSP system of claim 13, wherein the programmable instructions further cause the processor to update the stacked migration depth values using the re-migrated VSP data.

15. The VSP system of claim 14, wherein the programmable instructions further cause the processor to update the semblance panel using the updated, stacked depth migration depth values.

16. A computer system comprising:
a processor:
a memory coupled to the processor, wherein the memory stores programmable instructions, that when executed by the processor, cause the processor to:
receive vertical seismic profile (VSP) data output by a plurality of receivers positioned at different depths of a wellbore in response to seismic energy application at a plurality of offsets relative to a well head of the wellbore based on a walkaway VSP survey;
migrate the VSP data output by the respective receivers using an initial velocity model to produce migrated depth values associated with the respective receivers;
sort and collect the migrated depth values corresponding to each receiver to produce a migrated common receiver gather (CRG) associated with each receiver;
stack the migrated depth values of the CRGs corresponding to respective fixed lateral positions in an image volume to produce a common image gather (CIG) associated with each lateral position;
generate a semblance panel having the stacked depth migration values plotted as contours on a first axis for velocity ratio (vr), wherein the velocity ratio is based on migration velocity and true velocity, and a second axis for true depth (Zt); and
update the initial velocity model based on a plurality of data point selected from the semblance panel to provide an updated velocity model.

17. The computer system of claim 16, wherein the programmable instructions further cause the processor to re-migrate the VSP data using the updated velocity model.

18. The computer system of claim 17, wherein the programmable instructions further cause the processor to update the stacked migration depth values using the re-migrated VSP data and update the semblance panel using the updated, stacked depth migration depth values.

19. A non-transitory computer-readable medium storing instructions that, when executed by a processor, cause the processor to:
receive vertical seismic profile (VSP) data output by a plurality of receivers positioned at different depths of a wellbore in response to seismic energy application at a plurality of offsets relative to a well head of the wellbore based on a walkaway VSP survey;
migrate the VSP data output by the respective receivers using an initial velocity model to produce migrated depth values associated with the respective receivers;
sort and collect the migrated depth values corresponding to each receiver to produce a migrated common receiver gather (CRG) associated with each receiver;
stack the migrated depth values of the CRGs corresponding to respective fixed lateral positions in an image volume to produce a common image gather (CIG) associated with each lateral position;
generate a semblance panel having the stacked depth migration values plotted as contours on a first axis for velocity ratio (vr), wherein the velocity ratio is based on migration velocity and true velocity, and a second axis for true depth (Zt); and
update the initial velocity model based on a plurality of data point selected from the semblance panel to provide an updated velocity model.

20. The non-transitory computer-readable medium of claim 19, wherein the instructions further cause the processor to re-migrate the VSP data using the updated velocity model.
